(19) United States
(12) Patent Application Publication
(10) Pub. No.: US 2025/0094541 A1
(43) Pub. Date: Mar. 20, 2025

(54) GOVERNING USAGE OF AN ARTIFICIAL INTELLIGENCE TECHNOLOGY

(71) Applicant: International Business Machines Corporation, Armonk, NY (US)

(72) Inventors: John Thomas Richards, Honeoye Falls, NY (US); Manish Anand Bhide, Hyderabad (IN); Michael Hind, Cortlandt Manor, NY (US); Aleksandra Mojsilovic, New York, NY (US); Jacquelyn Martino, Cold Spring, NY (US); David John Piorkowski, White Plains, NY (US)

(21) Appl. No.: 18/468,079

(22) Filed: Sep. 15, 2023

(51) Int. Cl. G06F 21/10; G06F 21/62

(52) U.S. Cl. CPC G06F 21/106; G06F 21/62; G06F 2221/2141

(57) ABSTRACT

Techniques regarding the governing of use by a consumer of an artificial intelligence technology are described. For example, one or more embodiments described herein can comprise a system, which can comprise a memory that can store computer executable components. The system can also comprise a processor, operably coupled to the memory, and that can execute the computer executable components stored in the memory. The computer executable components can include an analyzing component that can, based on an artificial intelligence usage policy, analyze a proposed use by a consumer of an artificial intelligence technology, resulting in an analyzed use of the artificial intelligence technology. The computer executable components can further include a governing component that can, based on the analyzing, govern use by the consumer of the artificial intelligence technology.

### BACKGROUND

One or more embodiments relate to artificial intelligence technologies, and more specifically, to utilizing artificial intelligence technologies.

### SUMMARY

The following presents a summary to provide a basic understanding of one or more embodiments of the disclosure. This summary is not intended to identify key or critical elements, nor to delineate any scope of particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can facilitate governing usage of an artificial intelligence technology based on an artificial intelligence usage policy.

According to some embodiments described herein, a system is provided. The system can include a memory that stores computer executable components. The system can also include a processor, operably coupled to the memory, which can execute the computer executable components stored in the memory. The computer executable components can include analyzing component 132 that can, based on an artificial intelligence usage policy, analyze a proposed use by a consumer of an artificial intelligence technology, resulting in an analyzed use of the artificial intelligence technology. The computer executable components can further include governing component 134 that can, based on the analyzing, govern use by the consumer to the artificial intelligence technology, with the governed use being based on the artificial intelligence usage policy.

In additional, or alternative embodiments, the artificial intelligence usage policy can include a policy that governs use of the artificial intelligence technology based on factors that include but are not limited to, a hosting characteristic of the artificial intelligence technology, and a security characteristic of the hosting characteristic.

In additional, or alternative embodiments, the computer-executable components can further comprise a selecting component that can select the artificial intelligence technology from a set of available artificial intelligence technologies, based on the proposed use.

According to one or more example embodiments, a computer-implemented method is provided. The computer-implemented method can include, based on an artificial intelligence usage policy, analyzing a proposed use by a consumer of an artificial intelligence technology, resulting in an analyzed use of the artificial intelligence technology. The computer-implemented method can further include, based on the analyzing, governing use by the consumer of the artificial intelligence technology, wherein the governed use corresponding to the artificial intelligence usage policy.

In additional, or alternative embodiments, the computer-implemented method can further include receiving, by the device, task information corresponding to a generic task from the consumer, and based on analysis of the task information, generating, by the device, the proposed use of the artificial intelligence technology. In additional, or alternative embodiments, the artificial intelligence usage policy can include a policy that governs content of a prompt submitted to the artificial intelligence technology in furtherance of the proposed use of the artificial intelligence technology. In additional, or alternative embodiments, the artificial intelligence usage policy can include a policy that governs use of the artificial intelligence technology based on a controller entity of the artificial intelligence technology. In additional, or alternative embodiments, the second policy can govern use of the artificial intelligence technology based on a security characteristic of the controller entity.

In additional, or alternative embodiments, the computer-implemented method can further include selecting, by the device, the artificial intelligence technology from a set of available artificial intelligence technologies, based on the proposed use. In additional, or alternative embodiments, analyzing the proposed use of an artificial intelligence technology can further result in a determination of a level of risk associated with the proposed use of the artificial intelligence technology by the consumer, and the artificial intelligence usage policy can further include a policy that governs use of the artificial intelligence technology based on the level of risk.

In additional, or alternative embodiments, the artificial intelligence technology can include a generative language model, and the artificial intelligence usage policy can include a policy that governs use of the artificial intelligence technology based on content that was predicted to be generated in the proposed use of the generative language model. In additional, or alternative embodiments, the artificial intelligence technology can include a chain of artificial intelligence models. In additional, or alternative embodiments, the computer-implemented method can further include revising the artificial intelligence usage policy based on a result of the analyzed use of the artificial intelligence technology. In additional, or alternative embodiments, the artificial intelligence usage policy can include a policy that governs use of the artificial intelligence technology based on a characteristic of the consumer.

In additional, or alternative embodiments, the artificial intelligence usage policy can include a policy that governs use of the artificial intelligence technology based on a governmental regulation of a result of the proposed use. In additional, or alternative embodiments, the computer-implemented method can further include determining, by the device, a characteristic of training data that was used to generate a model controlling the artificial intelligence technology. In additional, or alternative embodiments, the computer-implemented method can further include generating a mitigation rule based on the proposed use, the consumer, and the artificial intelligence technology, and the artificial intelligence usage policy can include a policy that facilitates use of the artificial intelligence technology based on an application of the mitigation rule to the governing of use by the consumer to the artificial intelligence technology.

According to other example embodiments, a computer program product can facilitate governing usage of an artificial intelligence technology based on an artificial intelligence usage policy. The computer program product can comprise a computer readable storage medium having program instructions embodied therewith. The program instructions can be executable by a processor to cause the processor to, based on an artificial intelligence usage policy, analyze a proposed use by a consumer of an artificial intelligence technology, resulting in an analyzed use of the artificial intelligence technology. In different embodiments, the program instructions can further cause the processor to, based on the analyzing, enable governed use by the consumer to the artificial intelligence technology, wherein the governed use comprises use by the consumer governed by the artificial intelligence usage policy.

In additional or alternative embodiments, the artificial intelligence technology can include a generative language model, and the artificial intelligence usage policy can include a policy that governs use of the artificial intelligence technology based on content was predicted to be generated in the proposed use of the generative language model. In additional or alternative embodiments, the program instructions can further cause the processor to revise the artificial intelligence usage policy based on a result of the analyzed use of the artificial intelligence technology.

Other embodiments may become apparent from the following detailed description when taken in conjunction with the drawings.

### BRIEF DESCRIPTION OF THE DRAWINGS

In certain embodiments, the present invention is described with reference to accompanying figures. The figures provided herein are intended to facilitate a clear understanding of the invention and are not intended to limit the scope or functionality of the invention in any way.

FIG. 1 illustrates a block diagram of an example system that can facilitate governing usage of an AI technology based on an artificial intelligence usage policy, in accordance with one or more embodiments described herein.

FIG. 2 illustrates a block diagram of an example system that can facilitate governing usage of an AI technology based on an artificial intelligence usage policy, in accordance with one or more embodiments described herein.

FIGS. 3 illustrates a block diagram of an example set of characteristics that can describe the use of an artificial intelligence model, in accordance with one or more embodiments described herein.

FIG. 4 illustrates a block diagram of an example set of additional characteristics that can describe an artificial intelligence model, in accordance with one or more embodiments described herein.

FIG. 5 illustrates a block diagram of an example system that can facilitate governing usage of an AI technology based on an artificial intelligence usage policy, in accordance with one or more embodiments described herein.

FIG. 6 illustrates a flow diagram of an example, non-limiting computer-implemented method that can facilitate governing usage of an artificial intelligence technology based on an artificial intelligence usage policy, in accordance with one or more embodiments described herein.

FIG. 7 depicts an example computer-implemented system that can facilitate governing usage of an artificial intelligence technology based on an artificial intelligence usage policy, in accordance with one or more embodiments.

FIG. 8 depicts an example computer-program product that can include executable instructions that, when executed by a processor of a system, can facilitate governing usage of an artificial intelligence technology, in accordance with one or more embodiments.

FIG. 9 includes an example computing environment for the execution of at least some of the computer code involved in performing one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, with like referenced numerals being used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

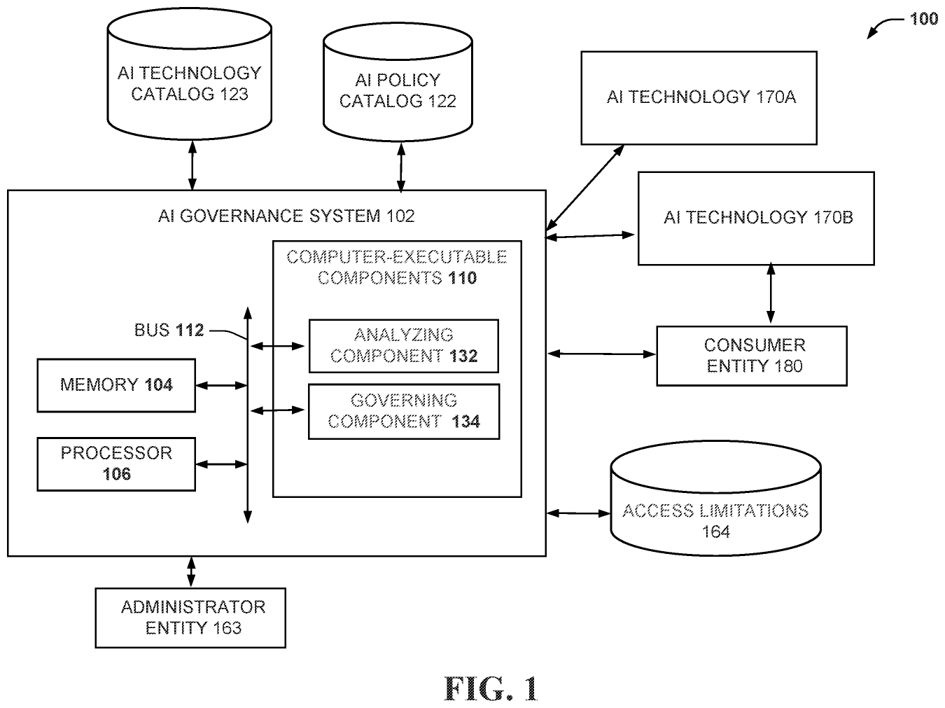

FIG. 1 illustrates a block diagram of an example, system 100 that can facilitate governing usage of an artificial intelligence (AI) technology based on an AI usage policy, in accordance with one or more embodiments described herein. Repetitive description of like elements and processes employed in respective embodiments is omitted for sake of brevity. In an example embodiment depicted, system 100 can include AI governance system 102 coupled to AI policy catalog 122, AI technology catalog 123, AI technologies 170A-B, consumer entity 180, administrator entity 163, and use limitations 164. According to multiple embodiments, AI policy catalog 122, AI technology catalog 123, AI technologies 170A-B (collectively “AI technologies 170”), and use limitations 164, represent stored data that can facilitate operation of one or more embodiments described herein.

System 100 and/or the components of system 100 can be employed to use hardware and/or software to solve problems that are highly technical in nature (e.g., related to multiple uses of multiple types of AI technologies including foundation models used to generate content) that are not abstract and that cannot be performed as a set of mental acts by a human. Further, some of the processes performed may be performed by specialized computers for carrying out defined tasks related to governing usage of AI technologies based on AI usage policies. System 100 and/or components of the system can be employed to solve problems that arise due to the availability of a broad variety of AI technologies some of which can be utilized to solve a broad variety of problems. In one or more embodiments, system 100 can provide technical safeguards for machine learning systems, deep learning systems, and AI systems by reducing risks associated with their use, and enabling the use of AI technologies for additional types of problems. In some implementations, system 100, through selection and governance of an appropriate AI technology, can improve the accuracy of an AI system, reduce delay in processing performed by processing components in a machine learning system, deep learning system and/or an AI system, and/or reduce computational overheads on neural networks and large language models, etc.

As is understood by one having skill in the relevant art(s), given the description herein, the implementation(s) described herein are non-limiting examples, and variations to the technologies described can be implemented. As such, any of the embodiments, aspects, concepts, structures, functionalities, implementations and/or examples described herein are non-limiting, and the technologies described and suggested herein can be used in various ways that provide benefits and advantages to govern the use of AI technologies, both for existing AI technologies and technologies in this and similar areas that are yet to be developed.

For instance, as used herein, AI technologies 170 can broadly reference different types of AI implementations, and even though specific AI technologies are discussed with examples herein, the approaches to governing the use of AI technologies described herein can also be used to govern the use of other AI implementations. An example AI technology for which use can be beneficially governed by embodiments includes a foundation model AI, e.g., a large, pre-trained machine learning model that can serve as a building block for a wide range of AI applications. A foundation model and other models (e.g., generative models) can typically be trained on massive amounts of text, images, or other types of data to learn patterns, associations, and representations within the data. They can then be fine-tuned or adapted for specific tasks or domains. Additionally, or alternatively, AI technologies 170 can refer to a chain of AI models, e.g., models linked in a sequence where the output of one model is used as input for a model in the chain. One or more embodiments can be configured to govern one or more of the models linked in the chain.

As used herein, an AI controller can broadly describe an entity that controls the operation of an AI technology, e.g., the location and security of computer hardware, the security of communications between the AI technology and the consumer entity, the administration of the AI technology (e.g., how the model is enabled to evolve over time), and/or other characteristics relevant to different embodiments described herein.

In some embodiments, AI governance system 102 can comprise memory 104, processor 106, and computer-executable components 110, coupled to bus 112. It should be noted that, when an element is referred to herein as being “coupled” to another element, it can describe one or more different types of coupling. For example, when an element is referred to herein as being “coupled” to another element, it can be described as one or more different types of coupling including, but not limited to, chemical coupling, communicative coupling, capacitive coupling. electrical coupling, electromagnetic coupling, inductive coupling, operative coupling, optical coupling, physical coupling, thermal coupling, and another type of coupling.

In one or more embodiments, AI governance system 102 can be operated using any suitable computing device or set of computing devices that can be communicatively coupled to devices, non-limiting examples of which can include, but are not limited to, a server computer, a client computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the AI governance system 102 and/or any other suitable device that can employ information provided by AI governance system 102 and can enable computer-executable components 110, discussed below. As depicted, computer-executable components 110 can include analyzing component 132, governing component 134, and any other components associated with AI governance system 102 that can combine to provide different functions described herein.

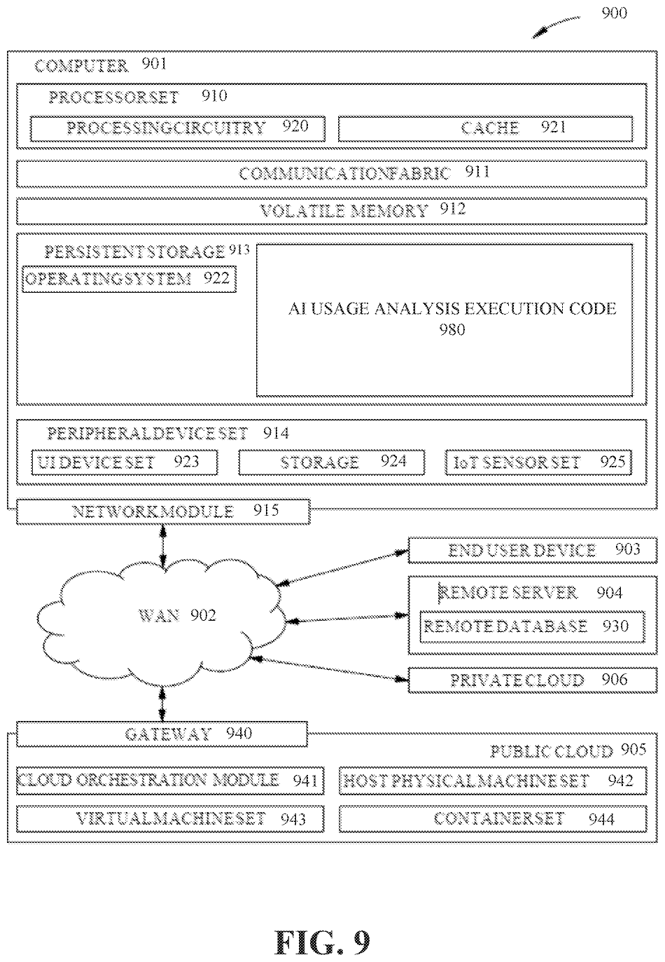

Memory 104 can comprise volatile memory (e.g., random access memory (RAM), static RAM (SRAM), dynamic RAM (DRAM), etc.) and non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to volatile memory 912 and FIG. 9. Such examples of memory 104 can be employed to implement any of the embodiments described herein.

In one or more embodiments, memory 104 can store one or more computer and machine readable, writable, and executable components and instructions that, when executed by processor 106 (e.g., a classical processor, and a quantum processor), can perform operations defined by the executable components and instructions. For example, memory 104 can store computer and machine readable, writable, and computer-executable components 110 and instructions that, when executed by processor 106, can execute the various functions described herein relating to AI governance system 102, including analyzing component 132, governing component 134, and other components described herein with or without reference to the various figures of the one or more embodiments described herein.

Processor 106 can comprise one or more types of processors and electronic circuitry (e.g., a classical processor, and a quantum processor) that can implement one or more computer and machine readable, writable, and executable components and instructions that can be stored on memory 104. For example, processor 106 can perform various operations that can be specified by such computer and machine readable, writable, and executable components and instructions including, but not limited to, logic, control, input/output (I/O), arithmetic, and the like. In some embodiments, processor 106 can comprise one or more central processing units, multi-core processor, microprocessor, dual microprocessors, microcontroller, System on a Chip (SOC), array processor, vector processor, quantum processor, and another type of processor. Further examples of processor 106 are described below with reference to processor set 910 and FIG. 9. Such examples of processor 106 can be employed to implement any embodiments described herein.

As discussed below, this stored data can have been generated by a type of artificial neural network (ANN), and be stored in storage that can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store information for embodiments and which can be accessed by the computer.

As depicted, memory 104, processor 106, analyzing component 132, governing component 134, and any other component of AI governance system 102 described or suggested herein, can be communicatively, electrically, operatively, and optically coupled to one another via bus 112, to perform functions of AI governance system 102, and any components coupled thereto. Bus 112 can comprise one or more of a memory bus, memory controller, peripheral bus, external bus, local bus, a quantum bus, and another type of bus that can employ various bus architectures. Additional implementation details of bus 112 are described below with reference to communication fabric 911 and FIG. 9. Such examples of bus 112 can be employed to implement any of the embodiments described herein.

In one or more embodiments described herein, AI governance system 102 can utilize analyzing component 132 to perform (e.g., via processor 106) operations including, but not limited to, analyzing based on an artificial intelligence usage policy, a proposed use by a consumer of an artificial intelligence technology, resulting in an analyzed use of the artificial intelligence technology. For example, in one or more embodiments, consumer entity 180 can provide a proposed use of an unspecified AI technology for analysis by analyzing component 132. Based on this analysis and different criteria described and suggested herein, AI technology 170A can be selected from AI technology catalog 123 and an AI usage policy can be selected from AI policy catalog 122. An example of execution code for performing this analysis is discussed with components of FIG. 9 below, e.g., AI usage analysis execution code 980.

As used herein a “consumer entity” of an AI technology can broadly refer to an entity that interfaces with the AI technology for the purpose of receiving and consuming (e.g., using) the results. As used herein, an “administrator entity” (e.g., administrator entity 163) can broadly refer to an entity that interfaces with AI governance system 102 to facilitate administrative functions that include, but are not limited to, configuration of maintenance of AI governance system 102. As used herein, the administrator and/or consumer entities are intended to encompass both a human and/or associated computing equipment.

In additional embodiments described herein, AI governance system 102 can utilize governing component 134 to perform (e.g., via processor 106) operations including, but not limited to, based on the analyzing, governing use by the consumer to the artificial intelligence technology. For example, in one or more embodiments, based on the analyzing, consumer entity 180 can be provided access to the artificial intelligence technology for the analyzed use, with this use being governed by the selected AI usage policy. In additional or alternative embodiments, as a part of the governed usage by consumer entity 180, use limitations 164 can be generated to mitigate risks associated with the analyzed use, e.g., usage mitigations described herein.

It should be appreciated that the embodiments described herein depict in various figures disclosed herein are for illustration only, and as such, the architecture of such embodiments are not limited to the systems, devices, and components depicted therein. For example, in some embodiments, AI governance system 102 can further comprise various computer and computing-based elements described herein with reference to sections below such as FIG. 9. In various embodiments, components of the AI governance system 102 (such as analyzing component 132 and governing component 134) can include functional elements that can be implemented via cloud technologies, physical components (for example, computer hardware) and local software (for example, an application on a mobile phone or an electronic device).

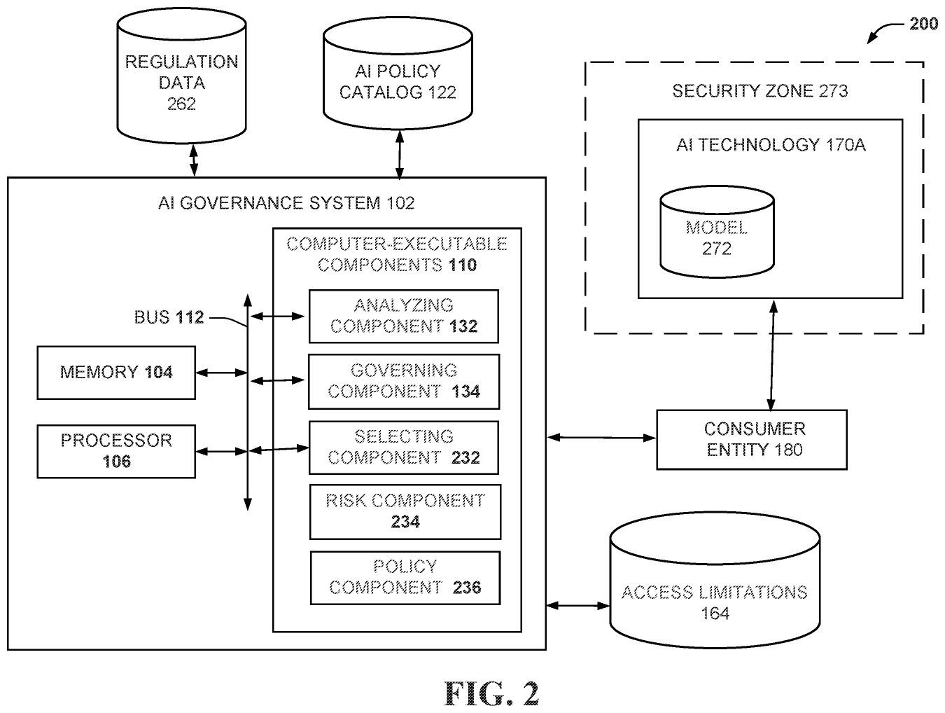

FIG. 2 illustrates a block diagram of an example, system 200 that can facilitate governing usage of an AI technology based on an AI usage policy, in accordance with one or more embodiments described herein. Repetitive description of like elements employed in one or more embodiments described herein is omitted for sake of brevity.

As depicted, system 200 includes an Al governance system 102 that includes additional elements. To further explain aspects of different embodiments, AI governance system 102 is further coupled to regulation data 262, and computer-executable components 110 further includes selecting component 232, risk component 234, and policy component 236. Additional details added to AI technology 170 include a designation that AI technology 170 is located (e.g., administered by) computing hardware in security zone 273. As discussed further below, the location and controller of the governed AI technology can be analyzed based on different criteria, e.g., security, efficacy, and performance.

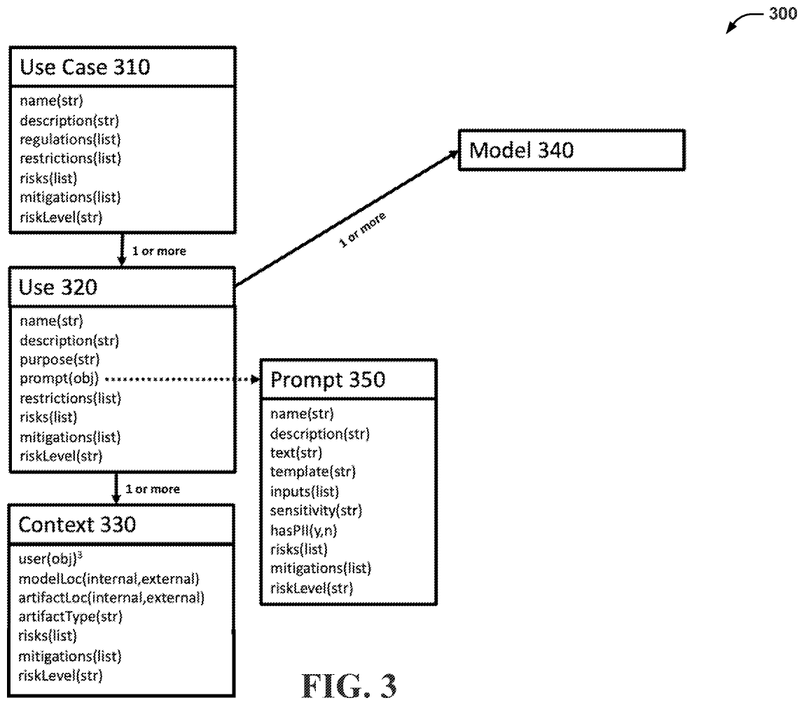

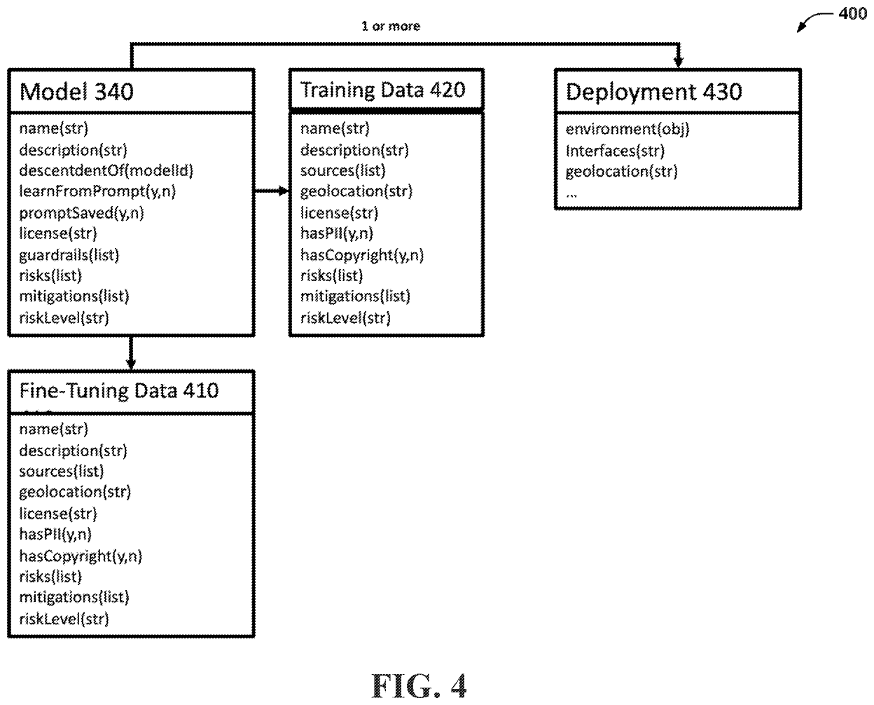

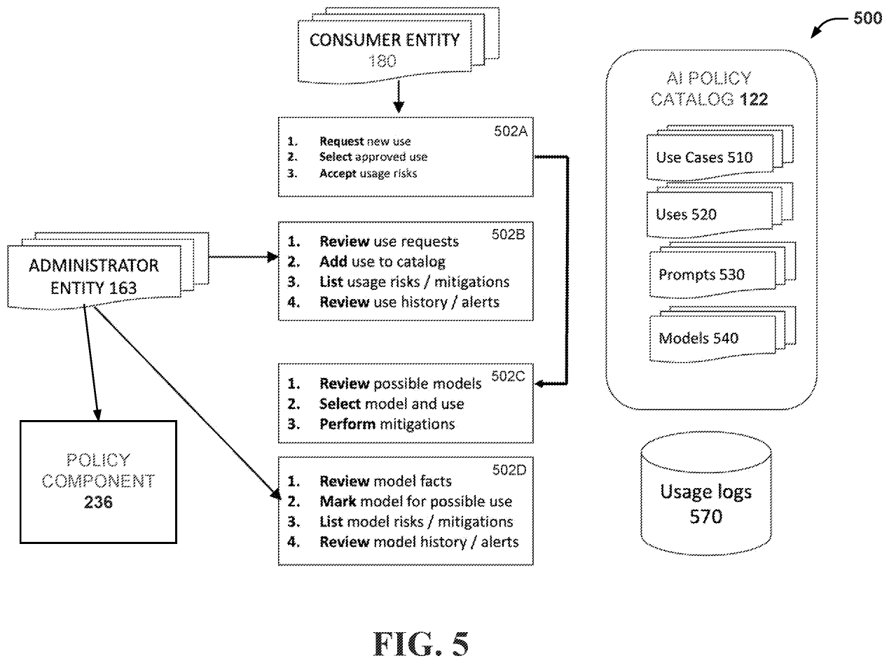

Regulation data 262 and selecting component 232 are described with a discussion of AI usage policies in FIGS. 3-4 below. Risk component 234 is described with a discussion of AI usage policies in FIGS. 4-5 below. Policy component 236 is described with a discussion of AI usage policies in FIG. 5 below. Security zone 273 is described with a discussion of AI usage policies in FIG. 3 below.

FIGS. 3 and 4 illustrate a block diagram of example set of linked data objects 300 and 400 that can describe governing the use of an AI technology, in accordance with one or more embodiments described herein. Repetitive description of like elements employed in one or more embodiments described herein is omitted for sake of brevity.

As depicted, linked data objects 300 and 400 include example characteristics that can broadly describe a usage of AI technology 170, e.g., use case 310, use 320, context 330, prompt 350, model 340, training data 420, deployment 430, and fine tuning data 410. These example characteristics are described below in a way intended to be non-limiting, e.g., with additional or fewer characteristics included in AI usage policies described herein.

In an example, use case 310 can include a higher-level construct (e.g., hiring and promotion) that is further particularized by a use 320 (e.g., automatic resume screening). While use case 310 can map to particular legal restrictions (e.g., a state regulation that regulates AI use for hiring), use 320 can include particular situations that are described with greater detail than use case 310, e.g., screening or sorting resumes to determine which applicants will be offered an interview. One or more embodiments can use AI usage policies to identify risks associated with a use that include, but are not limited to, unfair bias, spreading disinformation, intentional toxicity, non-consensual use of likenesses, dangerous uses, deceptive uses, and/or other similar risks. As with other applications of governmental regulations discussed herein, regulation data 262 of FIG. 2 can be used as a source of governmental rules for AI usage policies discussed herein. In an example implementation of linked data objects 300 and 400, use case 310 and use 320 can be reusable and can be listed in respective catalogs of use cases and uses, e.g., described with FIG. 5 below.

In one or more embodiments, context 330 can refer to a circumstance in which an AI technology is to be used. For example, these circumstances can include a particular consumer of the results of the model, the location of the model with respect to security zones (e.g., model 272 located in security zone 273), where the results of the model will be used (e.g., different legal jurisdiction can have different regulations pertaining to use), content of the result that is to be generated, where the result will be communicated, and/or other circumstances of the proposed use. In some implementations, because context 330 references a particular circumstance (e.g., combinations of time of use, consumer, prompt, controller of model, expected results, etc.), this object is generally not reused, being generated for each new circumstance. In addition, details about the particular consumer entity (e.g., user(obj) listed in context 330) can be retrieved from data systems, e.g., credentials, role, prior activity etc.

Prompt 350 can broadly describe the information communicated from the consumer to the AI technology to achieve the intended result of the use. This prompt 350 usage characteristic can be governed based on the governing rules discussed above, e.g., monitoring of proprietary data being submitted to a security zone that is outside the organization, and detection of regulated content such as personally identifiable information (PII). One or more embodiments can use AI usage policies to identify and manage risks associated with this characteristic that include, but are not limited to, limiting prompts from being accessed by unauthorized entities, and limiting prompts containing sensitive information being sent or accessed inappropriately.

Model 340 can refer to characteristics of the model, e.g., the training data that was used to train the model, a risk that the model will generate false data in response to use, and/or other similar characteristics of the model. One or more embodiments can use AI usage policies to identify and manage risks associated with model 340 characteristics that include, but are not limited to risk of, AI hallucinations, toxicity, specific attacks based on vulnerabilities, prompt injection, increased carbon emissions, and otherwise harmful or dangerous uses.

Continuing the discussion of computer-executable components 110, in one or more embodiments described herein, AI governance system 102 can utilize selecting component 232 to perform (e.g., via processor 106) operations including, but not limited to selecting the artificial intelligence technology 170A to use from a set of available artificial intelligence technologies (e.g., AI technology catalog 123), based on the proposed use from consumer entity 180.

In one or more embodiments, training data 420 and fine tuning data 410 can refer to data used to train the model, with differences in training content being associated with potential risks of different uses of the model. One or more embodiments can use AI usage policies to identify and manage risks associated with training data 420 characteristics that include, but are not limited to risks of results subject to, fairness/bias issues in the data, data poisoning, intellectual property issues, inclusion of PII/SPI in training data 420, licensed constraints on the use of the model, and/or falsehoods within the data.

Continuing the discussion of computer-executable components 110, in one or more embodiments described herein, AI governance system 102 can utilize risk component 234 to perform (e.g., via processor 106) operations including, but not limited to enumerating a set of risks and/or determining an overall level of risk associated with the proposed use of the artificial intelligence technology by consumer entity 180. For example, for the risks discussed herein that can be identified by embodiments as associated with one or more of use case 310, use 320, context 330, prompt 350, model 340, training data 420, deployment 430, and fine tuning data 410, risk component 234 can, by applying an AI usage policy, identify the associated risks and potentially reduce the risks or overall risk level to a level enabling the proposed usage.

FIG. 5 illustrates a block diagram of an example, system 500 that can facilitate governing usage of an AI technology based on an AI usage policy, in accordance with one or more embodiments described herein. Repetitive description of like elements employed in one or more embodiments described herein is omitted for sake of brevity. As depicted, system 500 includes a more detailed view of AI policy catalog 122, consumer entity 180, administrator entity 163, policy component 236, and usage logs 570. Different aspects of the uses of embodiments are shown with blocks 502A-D. As described in this section usage of AI technology 170 can also be termed, to ‘use a model,’ e.g., with characteristics described with FIGS. 4-5 above.

In an example of embodiments depicted in FIG. 5, block 502A includes actions to: request a new use, select an approved use, and accept determined usage risks, e.g., determined by risk component 234. For example, consumer entity 180 can communicate a proposed use of AI technology 170A.

Block 502B includes actions to: review requested new use requests, add approved uses to AI policy catalog 122, list usage risks and generate risk mitigations to address risks, review use history/alerts. For example, administrator entity 163 can perform actions using aspects of governance system 102, e.g., analyzing component 132 can analyze the proposed use, and risk component 234 can assess the level of risk associated with the use and select potential mitigations. Continuing this example, based on the analysis of the proposed use, AI policy catalog 122 can provide an AI usage policy that can govern this use based on characteristics described with FIGS. 4-5 above, e.g., use cases 510, uses 520, prompts 530, and models 540.

At block 502C actions to review a possible model for which usage requests can be accepted, select and use a model for a requested usage, and perform the mitigations generated at block 502B, e.g., by risk component 234. For example, the requested use can be reviewed by administrator entity 163 and a selection of AI technology 170A can be made from AI technology catalog 123. In different implementations, the selected AI technology can be selected based on characteristics of the proposed use, e.g., discussed with FIGS. 4 and 5 above.

At 502D, actions to review model facts (e.g., characteristic of the model), mark a model for possible uses, list determined model risks and generated mitigations, and review model history/alerts, e.g., by analyzing usage logs 570. For example, administrator entity 163 can further analyze, based on the selected AI usage policy, the selected model, model risks, and potential mitigations.

Continuing the discussion of FIG. 5 and computer-executable components 110, in one or more embodiments described herein, AI governance system 102 can utilize policy component 236 to perform (e.g., via processor 106) operations including, but not limited to, revising an artificial intelligence usage policy of AI policy catalog 122 based on a result of the analyzed use of the artificial intelligence technology. In one or more embodiments, policy component can analyze usage logs to determine when the operation of AI usage policies of AI policy catalog 122 can be improved.

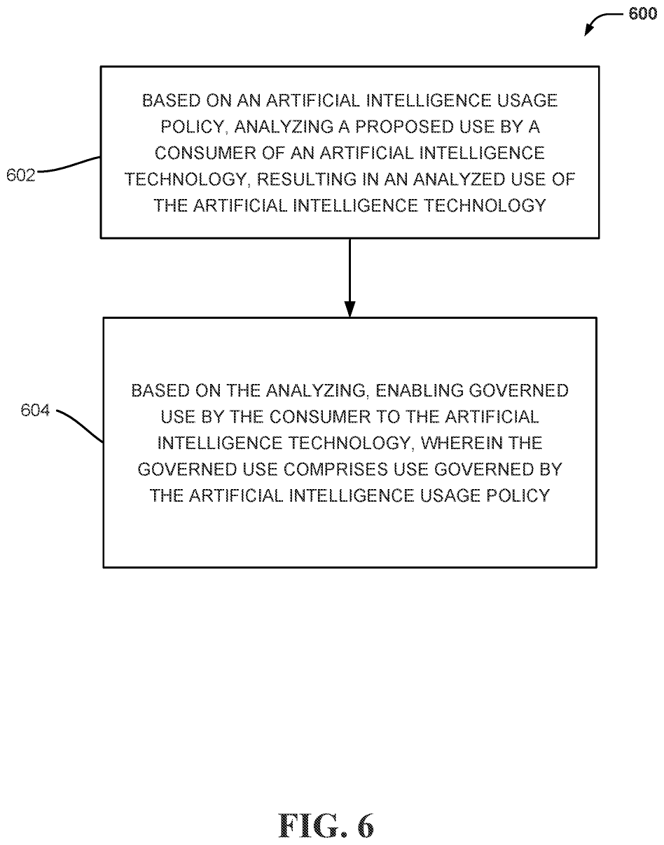

FIG. 6 illustrates a flow diagram of an example, non-limiting computer-implemented method 600 that can facilitate governing usage of an AI technology based on an AI usage policy, in accordance with one or more embodiments described herein. Repetitive description of like elements and processes employed in respective embodiments is omitted for sake of brevity.

At 602, computer-implemented method 600 can include, based on an artificial intelligence usage policy, analyzing a proposed use by a consumer of an artificial intelligence technology, resulting in an analyzed use of the artificial intelligence technology. At 604, computer-implemented method 600 can include, based on the analyzing, enabling governed use by the consumer of the artificial intelligence technology, with the governed use corresponding to the artificial intelligence usage policy.

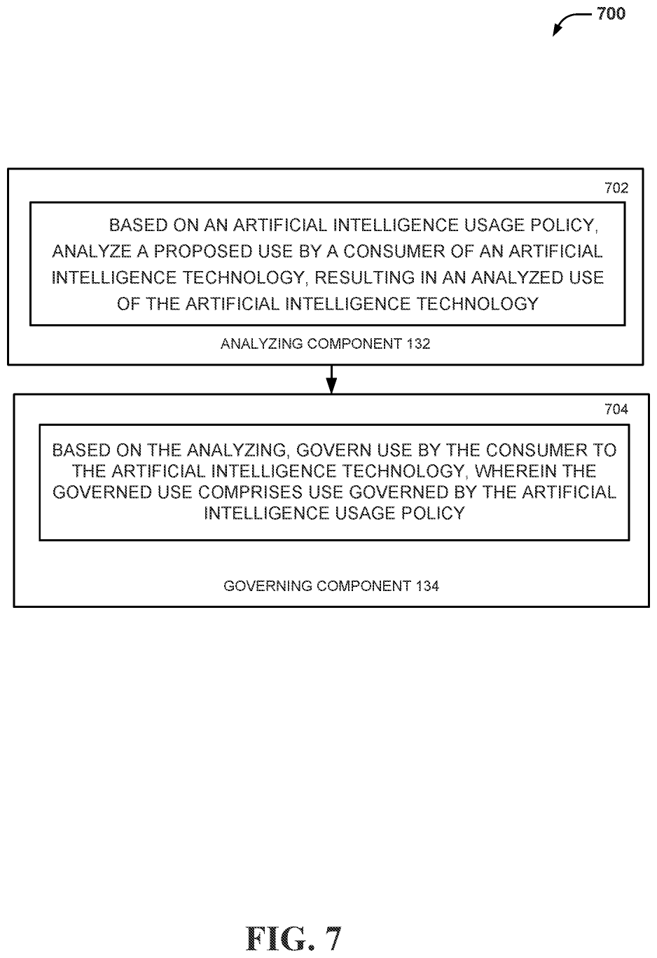

FIG. 7 depicts an example computer-implemented system 700 that can facilitate governing usage of an AI technology based on an AI usage policy, in accordance with one or more embodiments. For purposes of brevity, description of like elements and/or processes employed in other embodiments is omitted. Example computer-implemented system 700 can include analyzing component 132, governing component 134, and other components that can be used to implement aspects of computer-implemented system 700, as described herein, in accordance with one or more embodiments.

At 702 of FIG. 7, analyzing component 132 can analyze, based on an artificial intelligence usage policy, a proposed use by a consumer of the artificial intelligence technology, resulting in an analyzed use of the artificial intelligence technology. At 704 of FIG. 7, governing component 134 can facilitate, based on the analyzing, governing use of the artificial intelligence technology by the consumer.

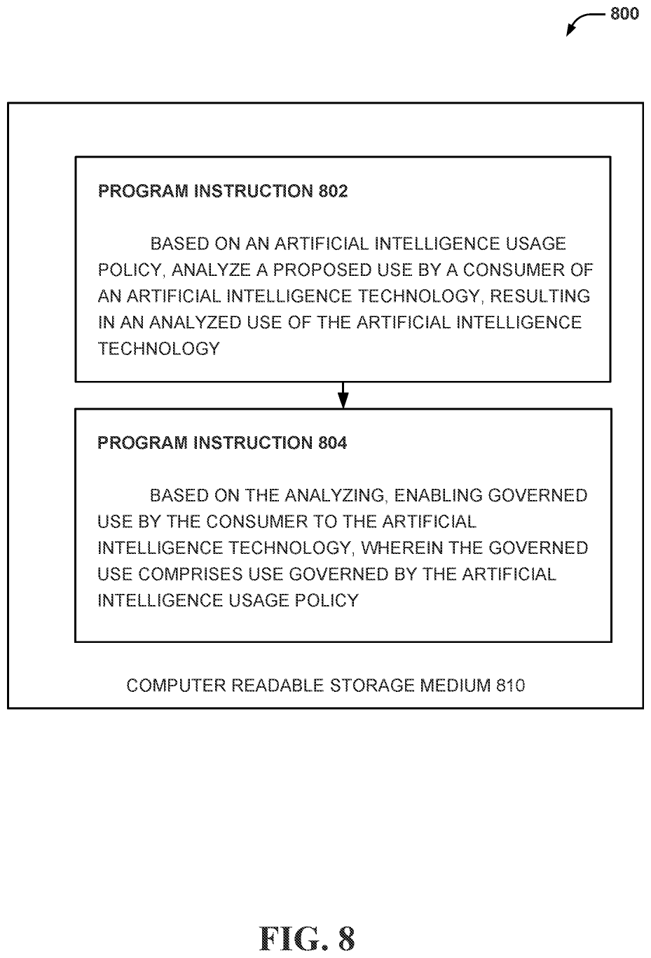

FIG. 8 depicts an example 800 computer-program product (CPP) that can include executable instructions that, when executed by a processor of a system, can facilitate governing usage of an artificial intelligence technology, in accordance with one or more embodiments. For purposes of brevity, description of like elements and/or processes employed in other embodiments is omitted.

In one or more embodiments, operation 802 of FIG. 8 can analyze, based on an artificial intelligence usage policy, a proposed use by a consumer of the artificial intelligence technology, resulting in an analyzed use of the artificial intelligence technology. In one or more embodiments, operation 804 of FIG. 8 can facilitate, based on the analyzing, use of the artificial intelligence technology by the consumer, wherein the use comprises use limited to use by the consumer corresponding to the artificial intelligence usage policy.

The operations described herein can be implemented as operations performed by an information/data processing apparatus on information/data stored on one or more computer-readable storage devices or received from other sources. In order to provide a context for the various aspects of the disclosed subject matter, FIG. 9 as well as the following discussion are intended to provide a general description of a suitable environment in which the various aspects of the disclosed subject matter can be implemented. FIG. 9 illustrates a block diagram of an example, non-limiting operating environment in which one or more embodiments described herein can be facilitated. Repetitive description of like elements employed in other embodiments described herein is omitted for sake of brevity.

Various aspects of the present disclosure are described by narrative text, flowcharts, block diagrams of computer systems and/or block diagrams of the machine logic included in CPP embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer-program product embodiment (“CPP embodiment” or “CPP” noted above) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 9 includes computing environment 900 as an example of an environment for the execution of at least some of the computer code involved in performing the inventive methods, such as implementation of an analysis component (e.g., analyzing component 132) by AI usage analysis execution code 980. In addition to block 980, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 980, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 980 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 980 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

What is claimed is:

1. A computer-implemented system, comprising:
a memory that stores computer-executable components; and
a processor, operably coupled to the memory, and that executes the computer-executable components stored in the memory, wherein the computer-executable components comprise:
an analyzing component that, based on an artificial intelligence usage policy, analyzes a proposed use by a consumer of an artificial intelligence technology, resulting in an analyzed use of the artificial intelligence technology, and
a governing component that, based on the analyzing, governs usage by the consumer of the artificial intelligence technology, wherein the governed usage comprises use by the consumer of the artificial intelligence technology, based on the artificial intelligence usage policy.

2. The computer-implemented system of claim 1, wherein the artificial intelligence usage policy comprises a policy that governs use of the artificial intelligence technology based on:
a hosting characteristic of the artificial intelligence technology, and
a security characteristic of the hosting characteristic.

3. The computer-implemented system of claim 1, wherein the computer-executable components further comprise a selecting component that selects the artificial intelligence technology from a set of available artificial intelligence technologies, based on the proposed use.

4. A computer-implemented method, comprising:
based on an artificial intelligence usage policy, analyzing, by a device operatively coupled to a processor, a proposed use by a consumer of an artificial intelligence technology, resulting in an analyzed use of the artificial intelligence technology; and
based on the analyzing, enabling, by the device, governed use by the consumer to the artificial intelligence technology, wherein the governed use comprises use by the consumer governed by the artificial intelligence usage policy.

5. The computer-implemented method of claim 4, further comprising:
receiving, by the device, task information corresponding to a generic task from the consumer; and
based on analysis of the task information, generating, by the device, the proposed use of the artificial intelligence technology.

6. The computer-implemented method of claim 4, wherein the artificial intelligence usage policy comprises a first policy that governs content of a prompt submitted to the artificial intelligence technology in furtherance of the proposed use of the artificial intelligence technology.

7. The computer-implemented method of claim 4, wherein the artificial intelligence usage policy comprises a second policy that governs use of the artificial intelligence technology based on a controller entity of the artificial intelligence technology.

8. The computer-implemented method of claim 7, wherein the second policy governs use of the artificial intelligence technology based on a security characteristic of the controller entity.

9. The computer-implemented method of claim 4, further comprising, selecting, by the device, the artificial intelligence technology from a set of available artificial intelligence technologies, based on the proposed use.

10. The computer-implemented method of claim 4, wherein the analyzing of the proposed use of an artificial intelligence technology further results in a determination of a level of risk associated with the proposed use of the artificial intelligence technology by the consumer, and wherein the artificial intelligence usage policy comprises a third policy that governs use of the artificial intelligence technology based on the level of risk.

11. The computer-implemented method of claim 4, wherein the artificial intelligence technology comprises a generative language model, and wherein the artificial intelligence usage policy comprises a fourth policy that governs use of the artificial intelligence technology based on content predicted to be generated in the proposed use of the generative language model.

12. The computer-implemented method of claim 4, wherein the artificial intelligence technology comprises a chain of artificial intelligence models.

13. The computer-implemented method of claim 4, further comprising, revising, by the device, the artificial intelligence usage policy based on a result of the analyzed use of the artificial intelligence technology.

14. The computer-implemented method of claim 4, wherein the artificial intelligence usage policy comprises a fifth policy that governs use of the artificial intelligence technology based on a characteristic of the consumer.

15. The computer-implemented method of claim 4, wherein the artificial intelligence usage policy comprises a sixth policy that governs use of the artificial intelligence technology based on a governmental regulation of a result of the proposed use.

16. The computer-implemented method of claim 4, further comprising, determining, by the device, a characteristic of training data that was used to generate a model that implements the artificial intelligence technology, wherein the artificial intelligence usage policy comprises a seventh policy that governs use of the artificial intelligence technology based on the characteristic of the training data.

17. The computer-implemented method of claim 4, further comprising, generating, by the device, a mitigation rule based on the proposed use, the consumer, and the artificial intelligence technology, wherein the artificial intelligence usage policy comprises an eighth policy that facilitates use of the artificial intelligence technology based on an application of the mitigation rule to the governed use by the consumer to the artificial intelligence technology.

18. A computer program product that governs use of an artificial intelligence technology, the computer program product comprising a computer readable storage medium having program instructions embodied therewith, the program instructions executable by a processor to cause the processor to:
analyze, based on an artificial intelligence usage policy, a proposed use by a consumer of the artificial intelligence technology, resulting in an analyzed use of the artificial intelligence technology; and
facilitate, based on the analyzing, use of the artificial intelligence technology by the consumer, wherein the use comprises use governed by the artificial intelligence usage policy.

19. The computer program product of claim 18, wherein the artificial intelligence technology comprises a generative language model, and wherein the artificial intelligence usage policy comprises a policy that governs use of the artificial intelligence technology based on content predicted to be generated in furtherance of the proposed use of the generative language model.

20. The computer program product of claim 18, wherein the program instructions further cause the processor to revise the artificial intelligence usage policy based on a result of the use of the artificial intelligence technology.
